(19) United States
(12) Patent Application Publication
(10) Pub. No.: US 2002/0059840 A1
(43) Pub. Date: May 23, 2002

(54) Automobile seat occupant sensing unit and vehicle seat fitted therewith

(76) Inventors: Robert Houston, Leichlingen (DE); Burckhard Becker, Solingen (DE); Siegfried Angerer, Friedberg (DE)

Correspondence Address: AKERMAN, SENTERFITT & EDISON, P.A., SUITE 400, 222 LAKEVIEW AVENUE, WEST PALM BEACH, FL, 33401, US

(21) Appl. No.: 10/045,196

(22) Filed: Nov. 9, 2001

(30) Foreign Application Priority Data
Nov. 9, 2000 (DE) 100 55 619.1

(51) Int. Cl. G01L 1/22

(52) U.S. Cl. 73/862.474

(57) ABSTRACT

The automobile seat occupant sensing unit has a sensor. The sensor consists of a sensor body and of at least one resistive strain gauge. The sensor body is provided with a main part and with at least one arm projecting from said main part. The main part is fitted with a fastening means for mounting the sensor and has a supporting surface. The at least one arm is elastically deformable in a direction transverse to the supporting surface, has a bearing area pointed toward a direction opposite the supporting surface and carries the at least one resistive strain gauge which is accommodated between the bearing area and the main part and which senses an elastic deformation of the at least one arm, said deformation being occasioned by the presence of an occupant in the vehicle seat.

### BACKGROUND OF THE INVENTION

The invention relates to an automobile seat occupant sensing device. Various sensing devices have been previously proposed. Pressure-sensitive mats for example are placed onto the actual seat area and provide a signal when an occupant sits in it.

This type of sensing device must be absolutely reliable. They are integrated into the occupant restraint system of a vehicle. When a sensing device provides the signal that no occupant is present in the corresponding seat, the thereto allocated airbag is not enabled for example.

On the other side, the sensing device must be capable of reliably distinguishing between a light load, exerted for example by a briefcase, a shopping-bag or perhaps an infant seat and a load exerted by an occupant. Accordingly, the device is only to be enabled when the load exceeds a predetermined value. All this signifies that the sensing device must very accurately detect the occupant in the seat and must additionally work with great reliability. The sensing device is moreover required to be utilizable for various vehicle seats and for various vehicles. Accordingly, the invention does not aim at finding an individual solution for one case, but is looking for a sensing device that may be applied universally on various constructions of vehicle seats and vehicles.

In view thereof, it is the object of the invention to provide a sensing device that may be utilized universally with differential models, that is robust and very reliable in practical use, that may be manufactured at low cost and that is simple to install.

### BRIEF SUMMARY OF THE INVENTION

The solution to this object is an automobile seat occupant sensing unit with a sensor, said sensor consisting of a sensor body and of at least one resistive strain gauge wherein said sensor body is provided with a main part and with at least one arm projecting from said main part, said main part being fitted with a fastening means for mounting the sensor and having a supporting surface, the at least one arm being elastically deformable in a direction transverse to the supporting surface, having a bearing area pointed toward a direction opposite the supporting surface and carrying the at least one resistive strain gauge which is accommodated between the bearing area and the main part and which senses an elastic deformation of the at least one arm, said deformation being occasioned by the presence of an occupant in the vehicle seat.

This sensing unit permits detection of the weight or of part of the weight of the occupant present in the corresponding vehicle seat. What is thereby detected is the flexure path of the sensor when it flexes on account of a load being exerted onto the seat. The amount of flexure is relatively small. It is not to be noticed by an occupant of a seat. It typically amounts to less than 1 mm. It is detected by a flexion of the at least one arm, said flexion being determined by way of the at least one resistive strain gauge.

The sensor is constituted by a sensor body and by at least one resistive strain gauge. The complete sensing apparatus also comprises an electric interpretation unit and further electric circuits. The sensor body has a main part that substantially serves to support or fasten the sensor. At least one arm is preferably integrally formed therein and protrudes therefrom. The main part is furthermore provided with a supporting surface that may also be considered as a datum plane for measuring deformations. The arm has a bearing area. If the position of the bearing area relative to the main part, more specifically relative to the supporting surface, changes, this change of position is signalled.

The indication, i.e., the output signal of an interpreting electronics connected behind the device, is thereby a function of the deformation of the at least one arm. The output signal is preferably proportional to the deformation, i.e., to the change in the distance separating the bearing area from the supporting surface. This is at least true in a normal range of application.

The sensitivity of the sensing apparatus may be increased and the indication become more reliable by providing more than one resistive strain gauge and more than one arm. It proved to be particularly appropriate to provide two resistive strain gauges on differential opposite areas of the arm. In other words, one portion of the arm is located between two resistance strain gauges. When submitted to a load, the one of the two resistive strain gauges detects an extension and the other a compression. As a result thereof, the signal obtained is approximately double the size of the signal obtained with but one resistance strain gauge. The sensor bodies of preference have two arms that protrude in opposite directions from the main part.

The sensing unit according to the invention is very easy to install. In a particularly preferred application, it is placed onto a fastening screw for fastening the vehicle seat to an underbody and is accordingly located on the underside of a bottom rail of the vehicle seat. In this embodiment, the main part has a hole that in this case constitutes the fastening means. It is realized in such a way that it is oriented transversally to the supporting area.

It is also possible to fasten the sensing unit somewhere else on the vehicle seat though. The place of particular preference is always an underside of a bottom rail of a longitudinal adjusting device of the vehicle seat or the upper side of an underbody, e.g. of a bracket. The sensing unit may for example be glued, welded or fastened by any other means onto the underside of a bottom rail in proximity to a fastening screw.

The sensing unit can be industrially produced in large quantities at low cost and with great accuracy. It is thereby particularly advantageous to have the resistive strain gauges arranged directly onto the sensor body. For this purpose it proved to be advantageous to make the sensor body out of an electrically nonconductive material. The material of choice for manufacturing the sensor body are ceramic materials, break-proof, elastic plastics, such as e.g., strongly armoured epoxy resins like for example epoxy resins charged with metal powder, sintered materials, composite materials.

It is also possible though to realize the sensor body in such a way that it is nonconductive on its surface or in partial areas of its surface only. In these embodiments too, the resistive strain gauges can be arranged direct onto the sensor body, that is, individual, prefabricated resistive strain gauges need not be deposited onto the sensor body. The resistive strain gauges may for example be vapor-deposited onto the sensor body. The same manufacturing processes may be used that are employed for manufacturing the gauge strips that are nowadays sold separately on the market. The supply lines need thereby not be realized as individual wires, they may on the contrary be arranged directly onto the sensor body. The techniques that can be used therefore are those known from the semiconductor technology, specifically vapor deposition, sputtering or any other method of depositing strip conductors, connecting points and the like. The required electric circuits, which are realized as chips, may thereby be directly connected to the sensor body. As a result thereof, the only thing still required is an electrical supply line for the connection to the on-board electronics of the vehicle or to a central signal interpreting device which is then located outside of the vehicle seat.

The sensing unit has the advantage that it may be universally used. It is even suited to retrofit already existing vehicles. The sensor and the elastic element may be realized according to a quite small and flat design so that they eventually do not take more space than a washer and so that they are not much more complicated to install than a washer. Usually, a seat is connected to the underbody by way of four screws, bolts or the like. One sensing unit is allocated to each screw and so on.

The sensing unit is absolutely robust. Resistance strain gauges have proved to be reliable. They present low impedance which entails ease of electrical interpretation. The resistance strain gauges of preference are made of constantan.

In a particularly preferred embodiment, the at least one arm is provided with an area of elastic deformation that is configured to elastically deform across the supporting surface, the at least one resistance strain gauge being furthermore allocated to that area of deformation. The resistance strain gauge thus captures the deformation induced by weight at the very location where it takes place.

The resistance strain gauges of preference are produced as films, wires and semiconductors. It is also possible to use magnetoelastic force-measuring sensors (e.g., pressductors).

Further advantages and characteristics will become apparent in the remaining claims and in the following description of exemplary embodiments of the sensing device and of its installation that are not limiting the scope of the invention and that are explained in more detail with reference to the drawing.

### BRIEF DESCRIPTION OF THE SEVERAL VIEWS OF THE DRAWINGS

FIG. 1 is a perspective view of a sensor with a total of four resistance strain gauges and two arms,

FIG. 2 is an electrical connection diagram of a sensing unit with four resistance strain gauges of the sensor according to FIG. 1,

FIG. 3 is a sectional view of a bottom rail of a longitudinal adjusting device of a vehicle and of a portion of an underbody of a vehicle, a sensor being accommodated therein between,

FIG. 4 is a perspective view of a sensor with but one arm and two resistance strain gauges,

FIG. 5 is a view according to FIG. 3 for the condition of incorporation of a sensor in a way similar to the one in FIG. 4,

FIG. 6 is a perspective view of another exemplary embodiment of a sensor with one arm and four resistance strain gauges and

FIG. 7 is a perspective view of a sensor with two arms protruding side by side.

### DETAILED DESCRIPTION OF THE INVENTION

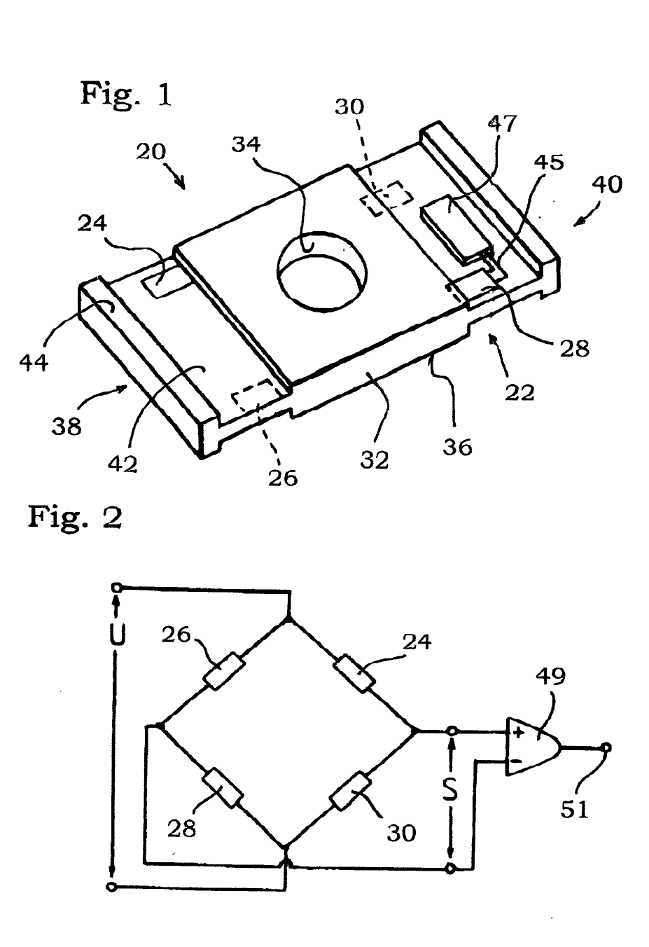

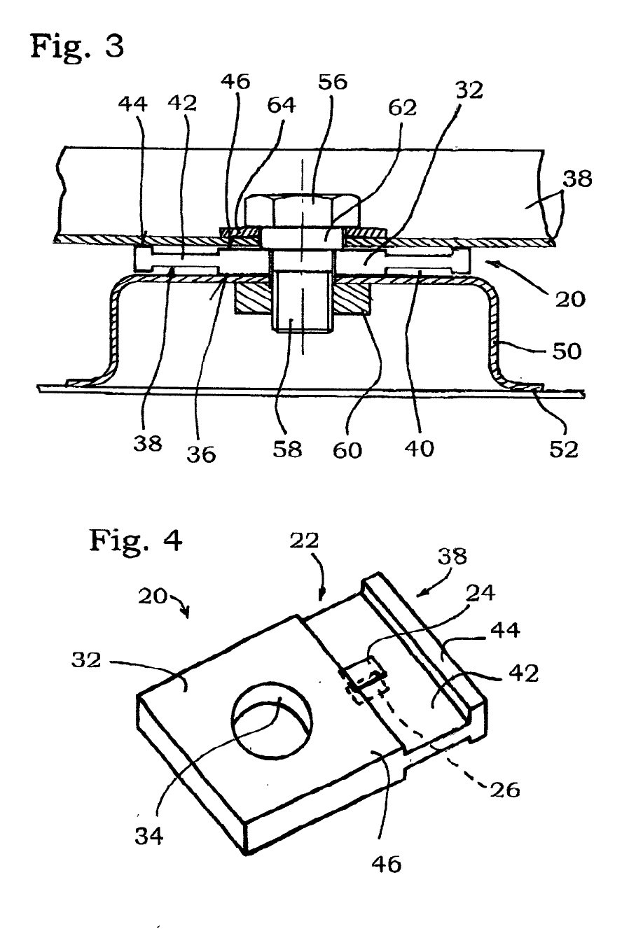

The sensor 20 according to FIG. 1 constitutes a preferred exemplary embodiment. It has one sensor body 22 and a total of four resistance strain gauges 24 to 30. Resistance strain gauges are also referred to as extension strain gauges, the reader is referred in this regard to Dubbel Taschenbuch für den Maschinenbau, (Dubbel's Pocketbook for Mechanical Engineering), 14^{th} edition. The sensor body 22 has a main part 32 that is a cube in the embodiment shown. The main part 32 has a central hole 34. On its underside, the main part 32 forms a supporting surface 36 which is substantially square. Arms 38, 40 protrude from the main part 32 into opposite directions. Seen from the side, the arms 38, 40 are T-shaped, the reader is more specifically referred to FIG. 3. They start from the main part 32, are at first provided with an area of deformation 42 and end in a thickening that has approximately the same thickness as the main part 32. A bearing area 44 that is directed toward an opposite direction relative to the supporting surface is located in the region of said thickening. The two bearing areas 44 of the two arms 38, 40 lie in one plane, an upper area of the main part 32 being spaced at no great distance therefrom, e.g., at 1 to 2 mm maximum. The supporting surface 36 lies in one plane, the lower ends of the thickening regions being spaced at a short distance therefrom, said distance being on the same order as the distance already mentioned.

In the embodiment according to FIG. 1 the bearing areas 44 are plane. They may also be crowned, designed as bezels, like points by way of one or several projections or have any other shape. The bearing areas 44 are designed in such a way that the introduction of force into the arms 38, 40 be as linear as possible and free of moment as well.

The resistance strain gauges 24-30 are accommodated in the region of deformation 42 that is tapered on either side. As shown in FIG. 1, a first resistance strain gauge 24 is accommodated on the upper side in proximity to a side border and in immediate proximity to the main part 32, another resistance strain gauge 26 of the same arm 28 is offset on the underside in proximity to the other side border. The accommodation of the resistance strain gauges 24, 30 on the other arm 40 is exactly reversed. Accordingly, the two resistance strain gauges 24, 28 that are accommodated on the upper side lie on one straight line that passes through the center of the hole 34. The same is true for the two resistance strain gauges 26, 30 that are located on the lower side and that are lying on a straight line that also passes through the hole 34. The two straight lines mentioned intersect to form an X.

The resistance strain gauges 24 to 30 are sheltered in the areas of deformation 42 which are provided with a cavity. Vapor-deposited connecting wires 45 and analyzing circuits are also accommodated in this protected region. An integrated circuit 47 is shown as an example thereof.

The width of the sensor 20 approximately corresponds to the width of a typical bottom rail 48 of a longitudinal adjusting device of a vehicle seat. The sensor 20 is shaped like a rectangular disc. It configures a plane double bending beam.

The sensor body 22 according to FIG. 1 is symmetrical about a plane that passes through the axis of the hole 34 and is normal to the thickening zones. The sensor body 22 also exhibits 2-fold symmetry about a plane that is defined by the axis of the hole 34 and is perpendicular to the first mentioned plane of symmetry.

The two-arm sensor may also assume an asymmetrical configuration. One arm may for example be shorter than the other arm. The shorter arm thereby has a thinner area of deformation 42 than the other arm.

FIG. 2 shows the electrical arrangement. The four resistance strain gauges 24 to 30 are interconnected in a Wheatstone bridge. A voltage U is applied on two opposite bridge points of said Wheatstone bridge. Voltage U may be constant voltage, alternating voltage or a mixture of constant and alternating voltage. Pulsed voltage may also be made use of. As shown in FIG. 2, the two top resistance strain gauges 24, 28 are facing each other in the bridge, the same is true for the two lower resistance strain gauges 26, 30.

On the two other bridge points that face each other, the signal S, i.e., the displacement of the supply voltage U by virtue of changes in resistance, is measured. For this purpose, a differential amplifier topped with a comparator can be connected. The comparator shown is realized as an operational amplifier 49. At its output 51, a signal appears that indicates whether the seat is occupied. Other electronic interpretations are possible. The electronic interpretation is devised in such a manner that the signal provided delivers unmistakable information of yes or no of whether the seat is occupied or not. Said signal is fed to a central on-board computer of the vehicle.

FIG. 3 shows the mounted condition. With its supporting surface 36, the main part 32 rests on a bracket 50 of an underbody 52 of a vehicle that is not illustrated in the drawings herein. On top thereof there is located a bottom rail 54 of a longitudinal adjusting device of a vehicle seat. Bracket 50 and bottom rail 54 are oriented substantially parallel to each other and present substantially plane supporting surfaces. The two bearing areas 44 of the two arms 38, 40 abut on the bottom rail 48. There is a clearance between the bottom rail 48 and the upper area of the main part 32. When the seat, and as a result thereof the bottom rail, are loaded, said clearance is reduced, this reduction being detected by the sensor. An assembly in reverse is also possible.

As shown in FIG. 3, there are clearances between the thickening zones and the bracket 50. The size of said clearances approximately corresponds to the clearance between the upper area and the bottom rail 48. When a maximum load is exerted, said clearances tend to zero. The sensor is secured against overloading since the forces are directly transmitted through the main part 32 or the two thickening zones when overload occurs.

As shown in FIG. 3, the bottom rail 48 is fastened to the underbody 52 by means of a screw 56. As contrasted with the previously known screw connection, the screw that is made use of is a stepped screw. On the top, the lower, narrower step 58 is pushed with its collar against the upper area 46 of the main part 32 and is screwed underneath the bracket 50 by way of a nut 60 that is designed here as a weld nut. As a result thereof, the main part 32 is firmly biased against the bracket 50. A second step 62 of the screw 56 biases the bottom rail 48 toward the main part 32 by way of an elastic element in the form of a spring washer 64. The magnitude of said biasing force, which is substantially determined by the elastic element 64, depends on the range of measurement wanted. The elastic element also permits to compensate for tolerances. A stepped nut, a normal screw with a distance bush, and so on may be utilized instead of a stepped screw.

It is also possible to relinquish the two steps, thus directly biasing the system seat rail/sensor (main part)/floor panel. This variant reduces the measuring sensitivity of the sensor, though.

In virtue of its constant cross section, the sensor body 22 can be produced in large quantities. Methods like extrusion, stamping or slitting with cutting into lengths are suited. The plane construction and the arrangement of the resistance strain gauges 24 to 30 permit automatic insertion.

The surface or the whole body of the sensor body 22 is preferably nonconductive. In that case, the resistance strain gauges 24 to 30 can be placed directly onto the surface of the sensor body 22. In this way, metal may for example be vapor-deposited and etched later on, it may be structured by means of a laser, and so on. Strip conductors are placed onto the surface of the sensor body 22.

FIG. 4 shows a sensor 20 with but one arm and only two resistance strain gauges 24, 26. They are facing each other in the tapered area of deformation 42, each being arranged on the center line of the arm 38. Since in this case there are only provided two resistance strain gauges 24, 26, only half of a Wheatstone bridge is realized, fixed resistors being substituted for the two lacking resistance strain gauges.

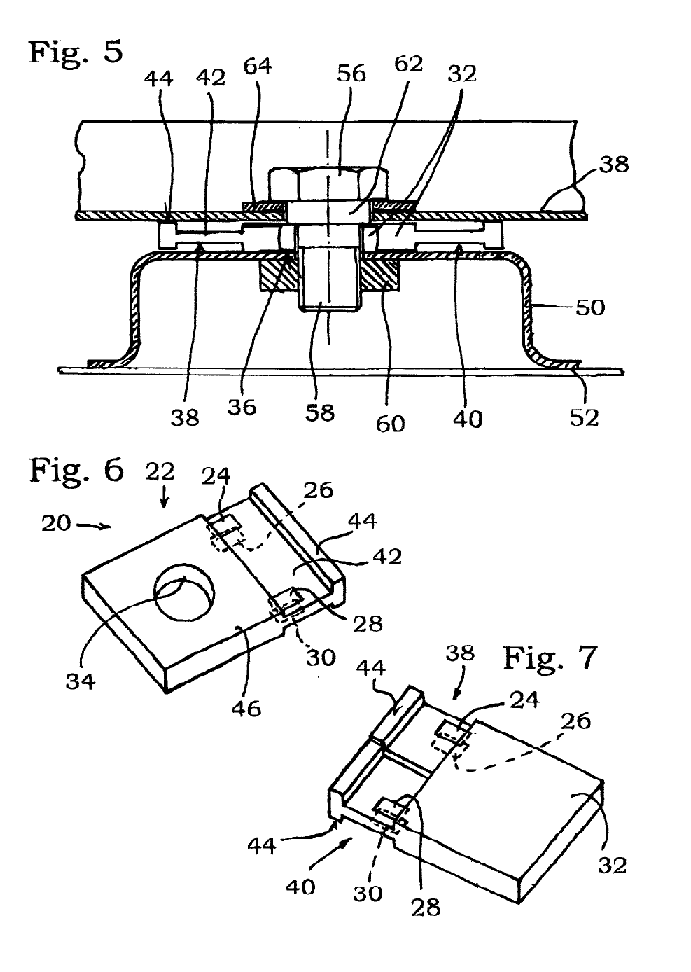

FIG. 5 shows a mounted sensor in a way similar to FIG. 1. Unlike the assembly according to FIG. 3, the sensor body 22 is now divided into an inner ring, which is clamped, and into an outer region. Both are in contact along an annular area that rests on a ball whose center is situated in the center of the hole 34. As a result thereof, the outer part can adjust and compensate for deformations of the bracket 50. The same is true for deformations of the bottom rail 48. Alternatively, the main part may also be crowned in its lower part.

Like in the embodiment according to FIG. 4, the sensor 20 has but one arm 38 in the embodiment according to FIG. 6. This time however, two resistance strain gauges are respectively arranged on the upper side and on the lower side of the tapered region of deformation 42, a full bridge being formed as a result thereof. Again and like in FIG. 1, the resistance strain gauges 24 to 30 are arranged in proximity to the side borders, they are facing each other. Like in the other cases the arrangement is symmetrical.

FIG. 7 shows an embodiment of a sensor 20 in which two arms 38, 40 extend in the same direction parallel to each other from the sensor body 22. They are spring-mounted in different directions. As a result thereof, the bearing area 44 of the one arm 38 is located on top whereas the bearing area of the other arm 40 is located at the bottom. Accordingly, for the one arm 38, the supporting surface of the main part 32 is its lower area, whereas for the other arm 40, the opposite upper area of the main part 32 constitutes the supporting area. As contrasted with the other embodiments, the main part 32 has no hole. It is very well possible however that it be provided with one. In the embodiment shown, it is placed directly onto a bottom rail 48 or a bracket 50, being e.g., welded, glued or the like.

There are again provided four resistance strain gauges 24 to 30. Each arm 38, 40 has two resistance strain gauges. They are each arranged opposite a respective one of the gauges. The sensor 20 according to FIG. 7 is particularly suited for the herein above already mentioned direct bracing, i.e., a fastening without two steps.

We claim:

1. An automobile seat occupant sensing unit with a sensor, said sensor comprising a sensor body and at least one resistance strain gauge said sensor body being provided with a main part and with at least one arm projecting from said main part, said main part being fitted with a fastening means for mounting the sensor, said main part having a supporting surface, the at least one arm a) being elastically deformable in a direction transverse to the supporting surface, b) having a bearing area pointed toward a direction opposite the supporting surface and c) carrying the at least one resistance strain gauge which strain gauge is accommodated between the bearing area and the main part and which strain gauge senses an elastic deformation of the at least one arm, said deformation being occasioned by the presence of an occupant in a vehicle seat equipped with said automobile seat occupant sensing unit.

2. A sensing unit according to claim 1, wherein the fastening means is a hole in the main part that is oriented transversely to the supporting surface and is devised for receiving a screw for fastening the seat.

3. A sensing unit according to claim 1, wherein the sensor body has two arms that are projecting in opposite directions from the main part, each of the two arms carrying at least one resistance strain gauge and having a respective bearing area.

4. A sensing unit according to claim 1, wherein the at least one arm is provided with an elastic region of deformation that is realized to elastically deform across the supporting surface and wherein the at least one resistance strain gauge is allocated to said region of deformation.

5. A sensing unit according to claim 1, wherein the at least one arm is provided with two resistance strain gauges.

6. A sensing unit according to claim 1, wherein the sensor is arranged between a first area formed by an underbody of a vehicle and a second area formed by the underside of a bottom rail of a longitudinal adjusting device of the vehicle seat.

7. A sensing unit according to claim 6, wherein the main part of the sensor body is rigidly connected to one of the first area and the second area and wherein the at least one arm abuts on the other of the first area and the second area by its bearing area.

8. A sensing unit according to claim 6, wherein there is provided an elastic element that elastically biases the one of the first area and the second area on which the sensor body is not abutting toward the at least one arm of the sensor.

9. A sensing unit according to claim 6, wherein, when the vehicle seat is submitted to load, the one of the first area and the second area on which the sensor body is not abutting is capable of executing a movement relative to the other area on which the sensor body abuts.

10. A sensing unit according to claim 6 wherein the main part of the sensor body is firmly pressed against said one of the first area and the second area by means of an assembling means.

11. A vehicle seat with a bottom rail and with a sensing apparatus arranged on a lower surface of the bottom rail, said sensing apparatus comprising a sensor body and at least one resistance strain gauge, said sensor body being provided with a main part and with at least one arm projecting from said main part, said main part being fitted with a fastening means for mounting the sensor, said main part having a supporting surface, the at least one arm a) being elastically deformable in a direction transverse to the supporting surface, b) having a bearing area pointed toward a direction opposite the supporting surface and c) carrying the at least one resistance strain gauge which strain gauge is accommodated between the bearing area and the main part and which strain gauge senses an elastic deformation of the at least one arm, said deformation being occasioned by the presence of an occupant in the vehicle seat.
